(19) United States
(12) Patent Application Publication
(10) Pub. No.: US 2011/0055848 A1
(43) Pub. Date: Mar. 3, 2011

(54) LAUNCHING AN MIDP-BASED TARGET APPLICATION FROM A LAUNCHER APPLICATION

(75) Inventors: Jussi Vainionpää, Helsinki (FI); Ville Airo, Espoo (FI); Antti Poikela, Espoo (FI)

(73) Assignee: TELIASONERA AB, STOKHOLM (SE)

(21) Appl. No.: 12/736,612

(22) PCT Filed: Apr. 24, 2009
(86) PCT No.: PCT/FI2009/050322

§ 371 Date: Nov. 4, 2010

(30) Foreign Application Priority Data
Apr. 25, 2008 (FI) 20085377

(51) Int. Cl. G06F 9/46

(52) U.S. Cl. 719/313

(57) ABSTRACT

A method for launching a target application from a launcher application, said target application being an MIDP-based application, and both the target application and the launcher application being installed within a device having a Symbian operating system. The method comprises: the target application registering the launcher application in a Push Registry of the MIDP as an application allowed to have incoming connection, said registration including at least a port number for the incoming connection; the launcher application sending a request to the target application to open a TCP connection via the port defined in said registration; checking from the Push Registry that the launcher application is allowed to open the TCP connection to the target application; and if allowed by the Push Registry, opening a TCP connection between the target application and the launcher application.

### FIELD OF THE INVENTION

The present invention relates to MIDP applications, and more particularly to launching an MIDP-based target application from a launcher application.

### BACKGROUND OF THE INVENTION

An ever-increasing part of software development is associated with application programs developed onto various generally known and widely used platforms. A platform typically comprises basic hardware entities belonging to a given hardware environment, and basic software acting as the operating system. In case of an open platform, the configuration data on the hardware and the operating system software and on the essential application programming interfaces (APIs) are accessible to anyone, allowing also third parties to develop the application programs. Various open platforms are widely used both in computers and in devices closely related thereto, such as in mobile stations. Open platforms include for instance Java™, which is a purely software-based platform for use in both computers and mobile stations, and Symbian, which is designed for use particularly in a mobile communication environment.

The Mobile Information Device Profile (MIDP) is a specification published for the use of Java on embedded devices such as mobile phones and PDAs. MIDP is part of the Java 2 Platform, Mobile Edition (J2ME) and provides a standard Java runtime environment for said devices. MIDP is run on top of the Connected Limited Device Configuration (CLDC), which is a set of lower level programming interfaces. CLDC and MIDP provide the core application functionality required by mobile applications, in the form of a standardized Java runtime environment and a plurality of Java APIs.

Symbian OS, in turn, is a proprietary operating system, which is especially designed for handheld devices with limited resources, wherein memory-consumption issues, aiming to keep memory usage low and memory leaks rare, have been emphasized. A very significant amount of mobile handheld devices currently on market use Symbian OS. Devices using Symbian OS are typically programmed by a specialized C++ programming language, but they can also be programmed in other programming languages, such as OPL, Visual Basic, Perl, and also in Java2 ME; Symbian OS provides support for MIDP 2.0, i.e. the current version of MIDP.

However, in Symbian OS the inter-operability of application programs is limited such that Symbian OS does not support launching MIDP 2.0 applications from another application program. This prevents utilising the resources provided by a MIDP application in execution of another application. For example, a browser program of Symbian OS cannot launch a plug-in application programmed in accordance with MIDP 2.0.

### SUMMARY OF THE INVENTION

Now there has been invented an improved method and technical equipment implementing the method, by which this limitation can be circumvented. Various aspects of the invention include a method, an apparatus and a computer program product, which are characterized by what is stated in the independent claims. Various embodiments of the invention are disclosed in the dependent claims.

According to a first aspect, a method according to the invention is based on the idea of launching a target application from a launcher application, said target application being an MIDP-based application, and both the target application and the launcher application being installed within a device having a Symbian operating system. The method comprises: the target application registering the launcher application in a PushRegistry of the MIDP as an application allowed to have incoming connection, said registration including at least a port number for the incoming connection; the launcher application sending a request to the target application to open a TCP connection via the port defined in said registration; checking from the PushRegistry that the launcher application is allowed to open the TCP connection to the target application; and if allowed by the PushRegistry, opening a TCP connection between the target application and the launcher application.

According to an embodiment, after the registering of the launcher application, the target application and/or an application management software (AMS) of the MIDP starting to listen the registered port for any inbound notification requests.

According to an embodiment, in response to the target application not running, the AMS carrying out the checking from the PushRegistry whether the launcher application is allowed to open the TCP connection to the target application; and if allowed by the PushRegistry, the AMS starting the target application for opening the TCP connection.

According to an embodiment, the target application registering the launcher application in the PushRegistry by sending a PushRegistration attribute message, the message containing at least said port number in a ConnectionURL field and the name of the launcher application in an AllowedSender field.

According to an embodiment, the target application registering the launcher application in the PushRegistry by sending a registerConnection message, the parameters of the message containing at least said port number and the name of the launcher application.

The arrangement according to the invention provides significant advantages. The described registration procedure enables to circumvent the limitations of the non-Java applications not being able to launch a MIDP 2.0 compliant MIDlet. From the launcher application point of view, it only needs to be capable of establishing a basic TCP connection in order to launch the target application.

The further aspects of the invention include an apparatus and a computer program product arranged to carry out the method steps. These and other aspects of the invention and the embodiments related thereto will become apparent in view of the detailed disclosure of the embodiments further below.

### LIST OF DRAWINGS

In the following, various embodiments of the invention will be described in more detail with reference to the appended drawings, in which

FIG. 1 shows a high-level view of the MIDP implementation in a MID device; and

FIG. 2 shows a signalling chart of an application launching method according to an embodiment of the invention.

### DESCRIPTION OF EMBODIMENTS

In the following, the invention will be illustrated by referring to MIDP specification in general, and therefore some basic features of MIDP are disclosed only to the extent considered necessary for understanding the invention. For a detailed description of MIDP, a reference is made to the specification “Mobile Information Device Profile, v2.0 (JSR-118)”, Nov. 5, 2002.

The concept of mobile information devices (MIDs) may include various kinds of devices, including at least mobile telephones, personal digital assistant (PDA) devices and palmtop computers. It is also clear that such a wide variety of MIDs is provided with a wide variety of system software. For example, some MIDs may have a full-featured operating system that supports multi-processing and hierarchical file systems, while other MIDs may have small, thread-based operating systems with no notion of a file system. Therefore, the MIDP specifications impose minimal requirements for the MID's system software, but they rather concentrate on a set of APIs considered to be essential on broad portability, such as application delivery and lifecycle issues, networking, sound, user interface, etc. For the MID's hardware, the MIDP specifications also set down some minimal requirements regarding display, input means, memory, networking and sound.

Since the MIDP can be considered an extension to basic Java, the MIDP has similar syntax and semantics structure to those of Java. Like in Java, standard libraries, object classes and their inheritance, etc. are also used in the MIDP.

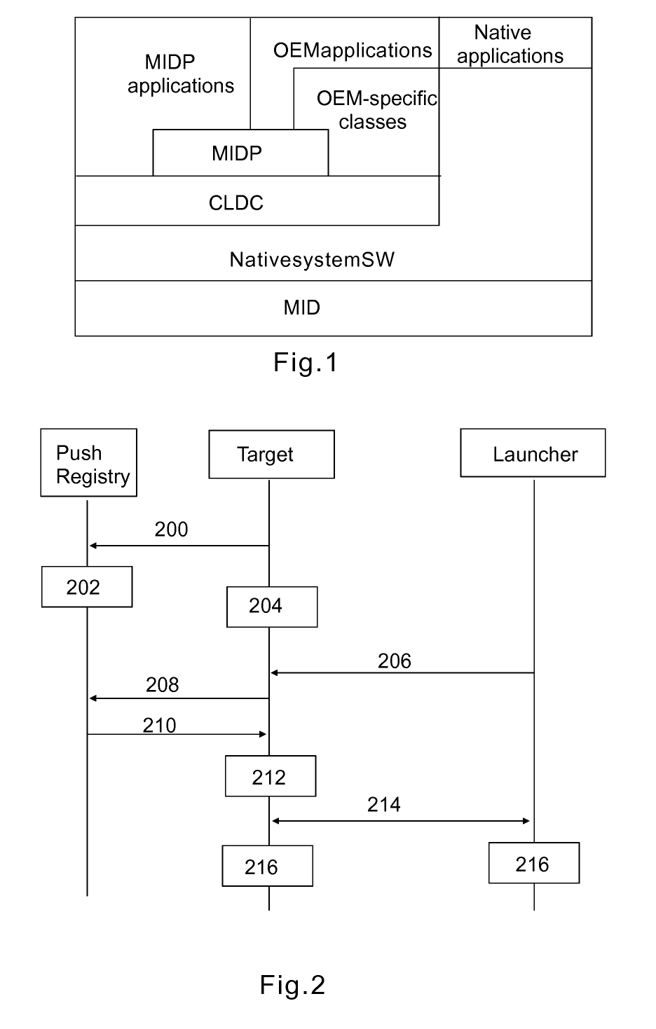

Thus, the MIDP provides an open, third-party application development environment for various MIDs. FIG. 1 illustrates a high-level view of the MIDP implementation in such a device, depicting however only an example how software layers may be arranged in the device. In FIG. 1, the lowest-level block (MID) represents the Mobile Information Device hardware, above which there is the native system software. This layer includes the operating system and libraries used by the device. In a Symbian device, this layer provides e.g. the Symbian operating system. Regarding the Java applications, the next layer of software comprises the CLDC, which carries out the Java Virtual Machine and associated libraries defined by the CLDC specification. This block provides the underlying Java functionality upon which higher-level Java APIs may be built.

Regarding the APIs on top of the CLDC, FIG. 1 illustrates APIs for two different types of applications, i.e. MIDP APIs, which are used by MIDP applications (i.e. MIDlets) purely in accordance with the MIDP and CLDC specifications, and OEM-specific APIs, which are used by OEM-specific applications depending, in addition to the MIDP-specific classes, also on classes that are not part of the MIDP specification (i.e. the OEM-specific classes). These classes may be provided by an OEM to access certain functionality specific to a given device. The OEM-specific applications may not be portable to other MIDs.

A further, but a more or less distinctive type of applications executable in a MID is a native application that is not written in Java, but it is rather built on top of the MID's existing, native system software. For example, in a Symbian device Symbian OS-specific applications belong to this category. Due to their non-Java nature, the native applications may experience compatibility problems with MIDlets in accordance with the MIDP and CLDC specifications. For example, regardless that the Symbian OS provides support for MIDP 2.0, the Symbian OS does not support launching MIDP 2.0 applications from another application program.

Now, in accordance with an aspect of the present invention, there has been invented a method for alleviating the problem. This solution is based on the use of a networking support feature, called PushRegistry, included in the MIDP 2.0, which maintains a list of inbound connections of MIDlets. An application can register the inbound connections with an entry in the application descriptor file or dynamically by calling the registerConnection method.

FIG. 2 illustrates the operation according to the embodiments. The operation is assumed to be carried out within a MID device having Symbian operating system extended with MIDP 2.0 support. The MID includes an application to be launched, i.e. the target application (“target”), which is preferably a MIDlet in accordance with the MIDP 2.0 specification. The application carrying out the launching of the target application is denoted as the launcher application (“launcher”). The launcher application may be any type of application, e.g. a Symbian-based application, a J2ME application etc.

The MIDP 2.0 in turn includes a number of software functionalities, but only the networking support feature PushRegistry, as being relevant to the invention, is disclosed in FIG. 2. PushRegistry belongs to a networking package of the MIDP 2.0 called javax.microedition.io, which provides the MIDlets with networking support based on the Generic Connection framework from the CLDC. The PushRegistry provides a MIDlet with a means of registering for network connection events, which may be delivered when the application is not currently running.

While an application is running, it is responsible for all I/O operations associated with the inbound connection. When the application is not running, the application management software (AMS) listens for inbound notification requests. When a notification arrives for a registered MIDlet, the AMS will start the MIDlet via a normal procedure, i.e. an invocation of MIDlet.startApp method.

However, in order to be launched by another application in the Symbian OS environment, the target application must first register a fixed port and filter connections allowing only incoming connections from within the MID device. According to an embodiment, this is performed by sending (200) a Push Registration attribute message to the PushRegistry, the message containing the following information fields: MIDlet-Push-<n>: <ConnectionURL>, <MIDletClassName>, <AllowedSender>.

Therein, the MIDlet-Push-<n> field is the Push registration attribute name, and the multiple push registrations of a MIDlet suite are distinguished by the consecutive numeric value for <n>. The ConnectionURL field is the connection string used in the invocation of the Connector.open( )method for opening input and output streams. This field defines the connection type and a port used for the connection. The MIDletClassName field is the MIDlet that is responsible for the connection. The named MIDlet must be registered in the descriptor file or the jar file manifest with a MIDlet-<n> record. The AllowedSender is a designated filter that restricts which senders (i.e. launcher applications) are valid for launching the requested MIDlet. The syntax and semantics of the AllowedSender field depend on the addressing format used for the protocol.

The Push Registration attribute message described above is meant for static connection registration. As an alternative, a registerConnection message could be used to register a dynamic connection with the application management software (AMS). Once registered, the dynamic connection acts just like a connection preallocated from the descriptor file. The arguments for the dynamic connection registration are the same as the Push Registration Attribute used for static registrations. Thus, the parameters define a connection, i.e. generic connection protocol, host and port number, a midlet, i.e. the class name of the MIDlet to be launched, when new external data is available, and a filter, i.e. a connection URL string indicating which senders are allowed to cause the MIDlet to be launched.

Once the connection registration (202) has been successfully completed, the target application starts to listen (204) the registered port. However, it should be noted that according to the MIDP 2.0 specification, the responsibility for registered push connections is shared between the AMS and the MIDlet (i.e. the target application) that handles the I/O operations on the inbound connection. The MIDlet is responsible for all I/O operations on the connection from the time it calls Connector.open( ) until it calls Connection.close( ) but before the Connector.open( ) call, the AMS listens for inbound connection notifications. Once the application has been started and the connection has been opened, the AMS is no longer responsible for listening for push notifications for that connection, but the application is responsible for reading all inbound data.

When the AMS is started, it checks the list of registered connections and begins listening for inbound communication. In order to launch the target application, the launcher application is arranged to send a notification request to open a TCP connection via the predefined port. When the notification arrives, the AMS checks (208) from the PushRegistry whether the launcher application is allowed to open the connection. If affirmative (210), the AMS starts the registered MIDlet (i.e. the target application), and the target application then opens (212) the connection with Connector.open( )method to perform whatever I/O operations are needed for the TCP connection type.

Once the TCP connection has been opened, it is then platform dependent what kind of start-up parameters, if any, and in which format must be specified separately. When the possible further parameters have been agreed on, the applications may carry out their mutual communication (214) through the TCP connection. After all required communication has been completed, the TCP connection can be closed (216). Both the target application and the launcher application preferably remain open and they can continue their execution independently.

Consequently, with this registration procedure the limitations of the non-Java applications not being able to launch a MIDP 2.0 compliant MIDlet are circumvented. The launcher application needs only to be capable of establishing a basic TCP connection in order to launch the target application.

A skilled man appreciates that any of the embodiments described above may be implemented as a combination with one or more of the other embodiments, unless there is explicitly or implicitly stated that certain embodiments are only alternatives to each other.

As becomes evident from above, the functionalities of the invention may be implemented in a MID device, such as a mobile station, as a computer program which, when executed in a central processing unit CPU or in a dedicated digital signal processor DSP, affects the terminal device to implement procedures of the invention. Functions of the computer program SW may be distributed to several separate program components communicating with one another. The computer software may be stored into any memory means, such as the hard disk of a PC or a CD-ROM disc, from where it can be loaded into the memory of mobile terminal. The computer software can also be loaded through a network, for instance using a TCP/IP protocol stack.

It is obvious that the present invention is not limited solely to the above-presented embodiments, but it can be modified within the scope of the appended claims.

1-6. (canceled)

7. A method for launching a target application from a launcher application, said target application being an MIDP-based application, and both the target application and the launcher application being installed within a device having a Symbian operating system, the method comprising:
the target application registering the launcher application in a PushRegistry of the MIDP as an application allowed to have incoming connection, said registration including at least a port number for the incoming connection; the target application and/or an application management software (AMS) of the MIDP starting to listen the registered port for any inbound notification requests;
the launcher application sending a request to the target application to open a TCP connection via the port defined in said registration;
in response to the target application not running, the AMS carrying out the checking from the PushRegistry whether the launcher application is allowed to open the TCP connection to the target application; and if allowed by the PushRegistry,
the AMS starting the target application for opening the TCP connection; and
opening a TCP connection between the target application and the launcher application.

8. The method according to claim 7, the method further comprising:
the target application registering the launcher application in the PushRegistry by sending a PushRegistration attribute message, the message containing at least said port number in a ConnectionURL field and the name of the launcher application in an AllowedSender field.

9. The method according to claim 7, the method further comprising:
the target application registering the launcher application in the PushRegistry by sending a registerConnection message, the parameters of the message containing at least said port number and the name of the launcher application.

10. An apparatus comprising:
a Symbian operating system;
an MIDP-based target application;
a launcher application;
the target application is arranged to register the launcher application in a PushRegistry of the MIDP as an application allowed to have incoming connection, said registration including at least a port number for the incoming connection; wherein
the target application and/or an application management software (AMS) of the MIDP are arranged to start listening the registered port for any inbound notification requests after the registering of the launcher application;
the launcher application is arranged to send a request to the target application to open a TCP connection via the port defined in said registration;
in response to the target application not running,
the AMS is arranged to check from the PushRegistry whether the launcher application is allowed to open the TCP connection to the target application; and if allowed by the PushRegistry,
the AMS is arranged to start the target application for opening the TCP connection; and
the target application and the launcher application are arranged to open a TCP connection between each other.

11. The apparatus according to claim 10, wherein
the target application is arranged to register the launcher application in the PushRegistry by sending a PushRegistration attribute message, the message containing at least said port number in a ConnectionURL field and the name of the launcher application in an AllowedSender field.

12. The apparatus according to claim 10, wherein the target application is arranged to register the launcher application in the PushRegistry by sending a registerConnection message, the parameters of the message containing at least said port number and the name of the launcher application.
